(19) United States
(12) Patent Application Publication
(10) Pub. No.: US 2026/0366946 A1
(43) Pub. Date: Nov. 19, 2026

(54) MONITORING SYSTEM AND METHOD FOR LEAKAGE OF MULTI-DIAMETER COMPATIBLE DETACHABLE WATER PIPELINES

(71) Applicant: TAIYUAN UNIVERSITY OF TECHNOLOGY, Taiyuan (CN)

(72) Inventors: Tingye QI, Taiyuan (CN); Tian QIU, Taiyuan (CN); Hongtao XU, Taiyuan (CN); Keji LI, Taiyuan (CN); Zhicheng ZHANG, Taiyuan (CN); Qi DING, Taiyuan (CN)

(73) Assignee: TAIYUAN UNIVERSITY OF TECHNOLOGY, Taiyuan (CN)

(21) Appl. No.: 19/369,456

(22) Filed: Oct. 27, 2025

(30) Foreign Application Priority Data
May 14, 2025 (CN) 2025106162224

(51) Int. Cl. G01M 3/18; H04W 24/08

(52) U.S. Cl. CPC G01M 3/18; H04W 24/08

(57) ABSTRACT

A monitoring system and method for leakage of multi-diameter compatible detachable water pipelines are provided, including a detachable hinged housing, a PLC controller, a ground signal base station, and a PC; the detachable hinged housing includes a C-shaped insulating housing and connectors thereof; and the C-shaped insulating housing is composed of two arc structures to form a C-shaped structure. The C-shaped insulating housing is equipped with a power supply, a resistor, water-absorbing resin, a sponge bundling device, a signal processing device, and several wires; and the wireless signal transmitter is connected to the ground signal base station, the PC, and the PLC controller in sequence. The present disclosure is constructed based on circuits and water-absorbing resin materials, and realizes pipeline water leakage monitoring through preset thresholds, ensuring accurate monitoring of areas prone to leakage accidents and effectively reducing losses and environmental pollution.

### CROSS-REFERENCE TO RELATED APPLICATIONS

The application claims priority to Chinese patent application No. 2025106162224, filed on May 14, 2025, the entire contents of which are incorporated herein by reference.

### TECHNICAL FIELD

The present disclosure relates to a monitoring system for leakage of multi-diameter compatible detachable water pipelines, which belongs to the technical field of pipeline leakage monitoring sensors.

### BACKGROUND

As the economy continues to develop, domestic and industrial water consumption increases year by year. A large number of water pipelines are laid every year, resulting in a complex water pipeline system and a large number of pipeline connection points. Water pipelines are prone to leakage under long-term water impact and corrosion. After repairs by maintenance personnel, they are still more likely to leak than in other areas. Therefore, it is necessary to focus on monitoring the leakage-prone areas at the connection and repair of water pipelines.

At present, there are relatively few monitoring sensors based on specific locations. Most of them are long-distance water pipeline monitoring sensors. The commonly used monitoring methods are performed based on acoustic and optical related data or manual inspections. Chinese patent application CN201711051548.9 discloses a water supply pipeline leakage locating and detecting system. A portable meter and a data acquisition unit form a distributed data acquisition system, which identifies the leak point location by detecting the propagation of abnormal signals of the pipeline with water leakage between two channels. However, this method is usually arranged in long-distance pipelines and cannot accurately monitor leakage-prone areas. Chinese patent application CN201820488427.4 discloses a device for monitoring pipeline leakage based on infrasound. A fastening mechanism, a signal processor and a time synchronization server, and a communication module and a terminal server are arranged at the upstream and downstream monitoring points of the pipeline to be monitored. The infrasound signal generated when the pipeline leaks is analyzed and processed by the signal processor and the time synchronization server to calculate the pipeline leakage point. However, there are many interference signals in the pipeline, and so many abnormal signals are detected. It is necessary to further analyze the signals in terms of time domain and frequency domain to extract features. Chinese patent application CN201910715214.X discloses an algorithm for optical fiber detection of pipeline leakage location in the frequency domain, which adopts an optical fiber to monitor the pipeline status, processes the optical fiber monitoring signal in the frequency domain combined with a signal enhancement algorithm, and finally obtains a reconstructed signal, thereby judging the pipeline status and leakage location. This method can realize continuous detection of the temperature of the entire pipeline, timely discover leaks by detecting abnormal changes in the temperature field around the pipeline, and accurately locate the leak point. However, in an environment with many personnel activities, the method will interfere with the temperature detection of the optical fiber, which is prone to false alarms, low alarm accuracy, high equipment cost, and high construction and maintenance requirements.

In summary, the development of a water pipeline leakage detection and alarm system is of great significance. Therefore, it is necessary to seek an innovative method that can effectively reduce monitoring costs and improves monitoring efficiency. The present disclosure aims to provide a system that can monitor special locations prone to leakage, such as water pipeline connections and post-leakage repair areas, with high monitoring precision, low false alarm rate, strong practicality, and low cost.

### SUMMARY

The present disclosure provides a circuit-based water pipeline leakage monitoring sensor, specifically providing a monitoring system for leakage of multi-diameter compatible detachable water pipelines to achieve effective monitoring of areas prone to pipeline leakage.

Principle of the present disclosure: Under long-term water impact and corrosion, leakage is prone to occur at the connection and repair of water pipelines. When pipeline leakage is detected, the water-absorbing resin and sponge bundling device become good conductors after absorbing water. At this moment, a short circuit happens and the current exceeds the current threshold of a signal processing device. The built-in relay circuit switch is automatically shut down and triggers a wireless signal transmitter to transmit signals through the ground base station to a PC, and the corresponding signal indicator lights up to remind the staff that a pipeline leak has occurred.

The present disclosure provides a monitoring system for leakage of multi-diameter compatible detachable water pipelines, including a detachable hinged housing, a PLC line controller, a ground signal base station, and a PC; the detachable hinged housing is arranged outside a pipeline to be monitored; the detachable hinged housing includes a C-shaped insulating housing and connectors thereof; and the C-shaped insulating housing is composed of two arc structures to form a C-shaped structure. One end of the two arc structures is a permeable mesh frame, the other end is connected to a connector, the permeable mesh frame is connected by a hinge, and the two arc structures are fixedly connected by a connector; the C-shaped insulating housing is equipped with a power supply, a resistor, water-absorbing resin, a sponge bundling device, a signal processing device, and several wires inside; the sponge bundling device is composed of a large number of sponge filaments connected together; and the signal processing device is composed of an ammeter, a relay circuit switch, and a wireless signal transmitter. The wireless signal transmitter is connected to the ground signal base station, the PC, and the PLC controller in sequence; the wireless signal transmitter will transmit a signal to the ground signal base station, and when the pipeline leakage signal is received, the ground signal base station transmits the signal to the PC; and when the pipeline leakage signal transmitted by the ground signal base station is received, the PC transmits the signal to the PLC controller to control a signal indicator of the corresponding device to flash, reminding the ground staff that the pipeline has leaked.

Preferably, the C-shaped insulating housing is made of an insulating plastic material, in which the water-absorbing resin is arranged above the permeable mesh frame at the bottom of the C-shaped insulating housing, and the water-absorbing resin is arranged in a clustered manner; when the C-shaped insulating housing is opened for disassembly, the clustered structure of the water-absorbing resin is staggered; when the C-shaped insulating housing is combined for assembly, the water-absorbing resin merges into one; and the arrangement of the water-absorbing resin is consistent with a line direction of the mesh in the permeable mesh frame, and when the amount of water absorbed by the water-absorbing resin is too large, water is discharged through the mesh.

Preferably, the connector of the C-shaped insulating housing includes a metal hook, two metal clamp rings, and four retractable mechanical rods; one end of the retractable mechanical rod is connected to the openings at both ends of the C-shaped insulating housing, and the other end is connected to the metal clamp ring; the two metal clamp rings are engaged with the metal hook for clamping connection, so that the C-shaped insulating housing is locked outside the pipeline; and sizes of the retractable mechanical rod can be adjusted according to the different diameters of the pipeline to be monitored. The bottom of the C-shaped insulating housing is connected by adopting a hinge structure, and the hinge structure includes a pair of blades with pin holes and a rotating shaft passing through the two blades to ensure that the C-shaped insulating housing can be flexibly opened and closed during assembly.

Further, the telescopic structure of each retractable mechanical rod is designed with multiple inner and outer tubes sleeved, the inner tube is nested inside the outer tube and the diameter of the inner tube gradually decreases; a certain gap is formed between the inner tube and the outer tube, allowing free sliding of the two; in order to control the sliding of the inner and outer tubes, a fixing ring is welded at the end of the outer tube where they are connected, and a fixing stay is mounted at the end of the inner tube; and when the retractable mechanical rod is needed, the inner tube is pulled outward until the stay is tightened to the fixing ring, and the mechanical rod can be fixed in its current location. The water pipeline to be monitored can be tightened by hooking the metal hook on the metal clamp ring on the other side; and when disassembling, the metal hook is taken out to separate the C-shaped insulating housing.

In the preceding solution, a retractable mechanical rod design is adopted to achieve functions in response to the monitoring needs of pipelines with different diameters (namely, multi-diameter compatibility). The mechanical rod can adapt to pipelines of various diameters by adjusting its length. When the metal hook is operated to separate it, since a hinge structure is provided at the bottom of the C-shaped insulating housing, the C-shaped insulating housing can move along the hinge, thereby adjusting the opening size to adapt to pipelines of different sizes, so that the system can effectively monitor leakage of water pipelines of different diameters.

In the C-shaped insulating housing, the water-absorbing resin is arranged adjacent to the sponge bundling device and there is no gap at the connection, they are regarded as an integer, and the integral structure is connected in parallel with the resistor; the power supply and the signal processing device are connected in series on the main circuit; and the water-absorbing resin is arranged at a central location of the C-shaped insulating housing, the sponge bundling device is arranged on both sides of the water-absorbing resin, the resistor is arranged in the middle area of the left side of the C-shaped insulating housing, and the power supply and the signal processing device are arranged in the middle area of the right side of the C-shaped insulating housing. The signal processing device is composed of an ammeter, a relay circuit switch, and a wireless signal transmitter. The ammeter is connected to the relay circuit switch, and the signal processing device has a built-in wireless signal transmitter. Further, a PVC waterproof tape is arranged at the connection between the wire and the sponge bundling device, tightly wrapping the wire and the sponge bundling device to prevent water from being sprayed onto the wire to form a closed loop when the water pipeline leaks and failing to trigger the alarm device.

Monitoring principle of the present disclosure: When a pipeline leaks, the water-absorbing resin and the sponge bundling device absorb moisture to short the circuit; at this moment, the current in the circuit exceeds the current threshold and triggers the relay circuit switch; after the signal is received, the wireless signal transmitter transmits the pipeline leakage signal to realize the detection process of the water pipeline leakage. After the power is turned on, a closed loop is formed; since the water-absorbing resin and the sponge bundling device are not conductive, the current returns to the negative electrode through the resistor; when the monitored pipeline leaks, the water-absorbing resin and the sponge bundling device absorb water and become good conductors; and at this moment, the circuit is short-circuited and the current exceeds the current threshold of the signal processing device, the built-in relay circuit switch is automatically shut down and triggers the wireless signal transmitter, and the wireless signal transmitter feeds back signals to the ground signal base station. After an abnormality is detected, the ground signal base station transmits a signal to the PC to trigger the PLC control system to alarm. The signal feedback principle is that when the current at the signal processing device exceeds the threshold, the relay circuit switch is automatically shut down to cut off the current to protect the power supply; and at the same time, the wireless signal transmitter transmits a leakage signal to the PC via the ground signal base station.

In the preceding solution, the current in the signal processing device is monitored in real time by a built-in ammeter, and the calculation equation is as follows:

$$t = \frac{U}{{R}_{Total}} \qquad ( 1 )$$

$$\frac{1}{{R}_{Total}} = \frac{1}{{R}_{1}} + \frac{1}{{R}_{2}} \qquad ( 2 )$$

Where, R₁ is the preset resistance, R₂ is the resistance formed by the water-absorbing resin and the sponge bundling device as an integer, and R_{Total} is the total resistance. When there is no leakage in the pipeline, R₂ approaches infinity, and the measured current is close to the current allowing the preset resistance; and when there is leakage in the pipeline, R₂ gradually approaches infinitesimal, at this moment, the measured current gradually increases and far exceeds the current threshold set in the signal processing device, thereby realizing the monitoring of water pipeline leakage.

In the preceding solution, each pipeline has a corresponding serial number, which can accurately correspond to each pipeline. The serial number corresponds to the signal indicator, and the signal indicator corresponding to the device is defined as Lᵢ; and then the working status of the signal indicator can be expressed as:

Lᵢ=n (3)

Lᵢ=y (4)

In Equations (3) and (4), n indicates that the signal indicator of the corresponding device works normally, indicating that there is no leakage in the pipeline; and y indicates that the signal indicator of the corresponding device works abnormally, indicating that there is a leakage in the pipeline and needs to be handled by staff.

In the preceding solution, the water-absorbing resin plays a role in preventing misjudgment. When water droplets or intermittent water flow are generated in the water pipeline due to external factors such as temperature difference between day and night, the water-absorbing resin can quickly and effectively absorb and lock in moisture, and will not diffuse to the sponge bundling devices at both ends to form a closed loop to cause misjudgment. When the water pipeline leaks and generates continuous water flow, it will exceed the retention capacity of the water-absorbing resin, thereby diffusing to the sponge bundling devices at both ends, thus forming a closed loop.

In the preceding solution, the power supply is lithium battery, which shall be checked and replaced by staff on a regular basis.

The present disclosure provides a monitoring method for leakage of multi-diameter compatible detachable water pipelines, including the following steps:
(1) arranging the water-absorbing resin and the sponge bundling device as an integer in the middle of the inner wall of the C-shaped insulating housing cavity, and forming a closed loop with the power supply, the resistor, and the signal processing device to monitor pipeline leakage;
(2) arranging all devices inside the C-shaped insulating housing cavity, in which the C-shaped insulating housing is fixed by a retractable mechanical rod, a metal clamp ring, and a metal hook, and can be adjusted accordingly according to the pipeline diameter, and the tip of the metal hook returns to the front end of the metal clamp ring to prevent the metal hook from falling off after assembly;
(3) bonding the wire and the sponge bundling device with conductive sol to quickly form a loop after encountering water, thereby accurately monitoring leakage;
(4) fixing the device at the pipeline connection point or maintenance point after the pipeline is arranged or repaired, turning on the power supply switch, starting the PC, monitoring the connection point or maintenance point in real time, and reflecting whether the pipeline leaks according to the current value, where when the pipeline leaks, the circuit current being higher than the current threshold set in the signal processing device will trigger the relay circuit switch to shut down the circuit, and at the same time, the wireless signal transmitter transmits a signal to the PC via the ground base station so as to realize accurate monitoring of leakage points; and
(5) monitoring the pipeline leakage in real time by the PC, where when a feedback abnormal signal is received, the PC will automatically transmit a signal to the ground PLC controller, and the indicator corresponding to the device serial number will flash to remind the ground staff, thereby avoiding the occurrence of water leakage accidents.

### Beneficial Effects of the Present Disclosure

(1) The present disclosure is constructed based on circuits and water-absorbing resin materials, and realizes pipeline water leakage monitoring through preset thresholds, ensuring accurate monitoring of areas prone to leakage accidents. In addition, relay circuit switches are used in the signal processing device to realize circuit protection. When it is abnormally closed due to leakage, the equipment can be reopened by switch adjustment after maintenance, realizing multiple recycling and effectively reducing losses and environmental pollution.
(2) The present disclosure adopts a snap-on retractable mechanical rod structure connection, which can realize the monitoring of multi-diameter pipelines and is easy to assemble and move. In addition, a signal processing device is arranged in the present disclosure. When the current is abnormal, the signal processing device synchronously transmits a signal to the PC via the ground base station and triggers an alarm device, thereby achieving real-time and rapid response to pipeline leakage.

### BRIEF DESCRIPTION OF DRAWINGS

FIG. 1 is a diagram of a monitoring system for leakage of multi-diameter compatible detachable water pipelines;

FIG. 2 is a circuit connection diagram of the monitoring system;

FIG. 3 is a schematic diagram of an assembly of a C-shaped insulating housing of a detachable hinged housing; and

FIG. 4 is a schematic diagram of the C-shaped insulating housing of the detachable hinged housing after being connected and assemble with the pipeline.

### REFERENCE NUMERALS

1. power supply; 2. PVC waterproof tape; 3. water-absorbing resin; 4. resistor; 5. sponge bundling device; 6. wire; 7. wireless signal transmitter; 8. relay circuit switch; 9. ammeter; 10. PLC controller; 11. signal indicator; 12. PC; 13. ground signal base station; 14. wireless signal; 15. signal processing device; 16. C-shaped insulating housing; 17. metal clamp ring; 18. metal hook; 19. integral structure of the water-absorbing resin and the sponge bundling device; 20. pipeline; 21. retractable mechanical rod; and 22. permeable mesh frame.

### DETAILED DESCRIPTION OF THE EMBODIMENTS

The present disclosure is further described by way of embodiments below, but is not limited to the following embodiments.

### Embodiment 1

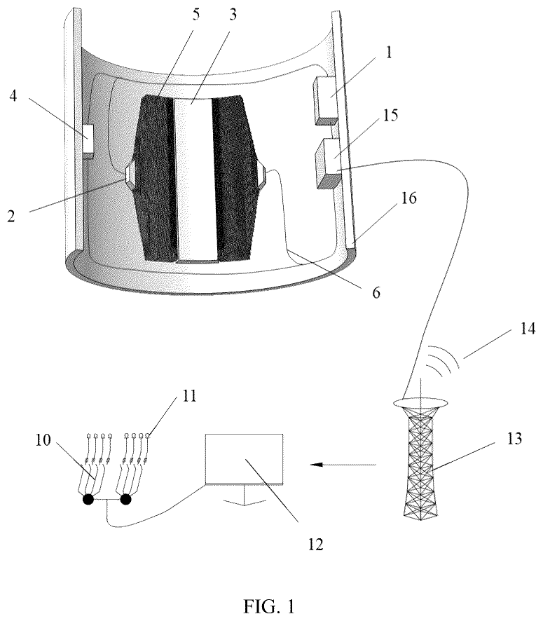

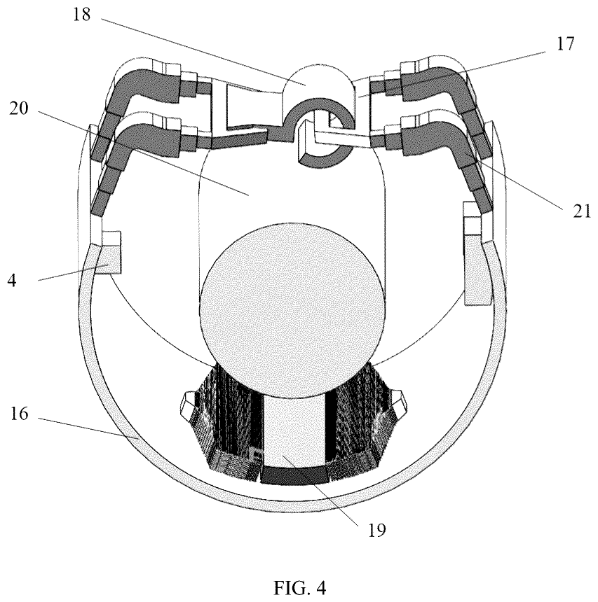

As shown in FIGS. 1 to 4, a monitoring system for leakage of multi-diameter compatible detachable water pipelines is provided, including a detachable hinged housing, a PLC line controller, a ground signal base station, and a PC; the detachable hinged housing is arranged outside a pipeline 20 to be monitored; the detachable hinged housing includes a C-shaped insulating housing 16 and connectors thereof; and the C-shaped insulating housing 16 is composed of two arc structures to form a C-shaped structure. One end of the two arc structures is a permeable mesh frame 22, the other end is connected to a connector, the permeable mesh frame 22 is connected by a hinge, and the two arc structures are fixedly connected by a connector.

The C-shaped insulating housing 16 is equipped with a power supply 1, a resistor 4, water-absorbing resin 3, a sponge bundling device 5, a signal processing device 15, and several wires 6 inside; the sponge bundling device 5 is composed of a large number of sponge filaments connected together; and the signal processing device 15 is composed of an ammeter 9, a relay circuit switch 8, and a wireless signal transmitter 7. The wireless signal transmitter 7 is connected to the ground signal base station 13, the PC 12, and the PLC controller 10 in sequence; the wireless signal transmitter 7 will transmit a signal to the ground signal base station 13, and when a pipeline leakage signal is received, the ground signal base station 13 transmits the signal to the PC 12; and when the pipeline leakage signal transmitted by the ground signal base station 13 is received, the PC 12 transmits the signal to the PLC controller 10 to control the signal indicator 11 of the corresponding device to flash, reminding the ground staff that the pipeline has leaked.

Specifically, the C-shaped insulating housing 16 is made of an insulating plastic material, in which the water-absorbing resin 3 is arranged above the permeable mesh frame 22 at the bottom of the C-shaped insulating housing 16, and the water-absorbing resin 3 is arranged in a clustered manner; when the C-shaped insulating housing 16 is opened for disassembly, the clustered structure of the water-absorbing resin 3 is staggered; when the C-shaped insulating housing 16 is combined for assembly, the water-absorbing resin 3 merges into one; and the arrangement of the water-absorbing resin 3 is consistent with a line direction of the mesh in the permeable mesh frame 22, and when the amount of water absorbed by the water-absorbing resin 3 is too large, water is discharged through the mesh.

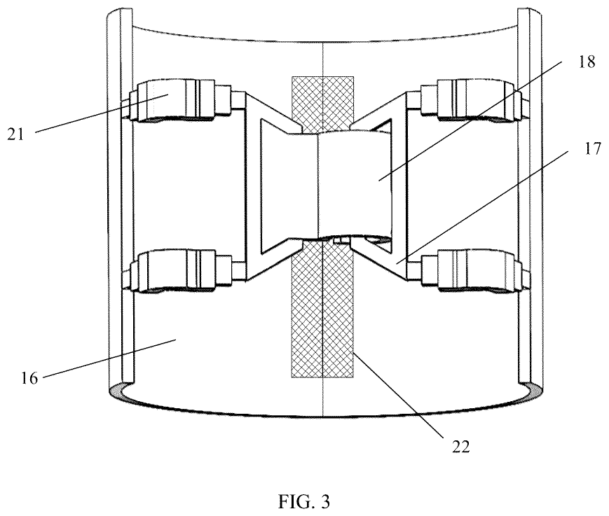

Specifically, as shown in FIG. 3, the connector of the C-shaped insulating housing 16 includes a metal hook 18, two metal clamp rings 17, and four retractable mechanical rods 21; one end of the retractable mechanical rod 21 is connected to the openings at both ends of the C-shaped insulating housing 16, and the other end is connected to the metal clamp ring 17; the two metal clamp rings 17 are engaged with the metal hook 18 for clamping connection, so that the C-shaped insulating housing 16 is locked outside the pipeline 20; and sizes of the retractable mechanical rod 21 can be adjusted according to the different diameters of the pipeline to be monitored. The bottom of the C-shaped insulating housing 16 is connected by adopting a hinge structure, and the hinge structure includes a pair of blades with pin holes and a rotating shaft passing through the two blades to ensure that the C-shaped insulating housing 16 can be flexibly opened and closed during assembly.

When disassembling, the metal hook 18 can be taken out to separate the C-shaped insulating housing 16. The telescopic structure of each retractable mechanical rod 21 is designed with multiple inner and outer tubes sleeved, the inner tube is nested inside the outer tube and the diameter of the inner tube gradually decreases; a certain gap is formed between the inner tube and the outer tube, allowing free sliding of the two; in order to control the sliding of the inner and outer tubes, a fixing ring is welded at the end of the outer tube where they are connected, and a fixing stay is mounted at the end of the inner tube; and when the retractable mechanical rod is needed, the inner tube is pulled outward until the stay is tightened to the fixing ring, and the mechanical rod can be fixed in its current location.

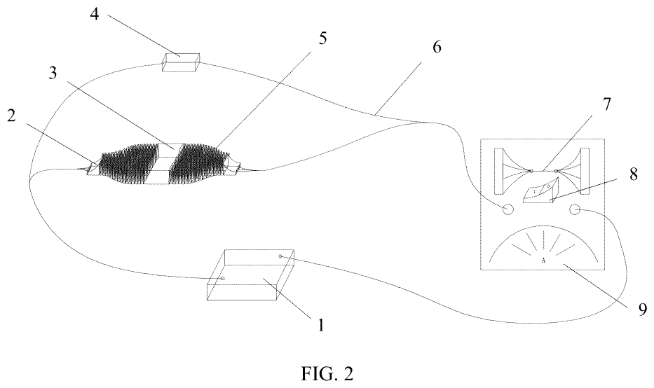

Monitoring principle of the present disclosure: In the C-shaped insulating housing 16, the water-absorbing resin 3 is arranged adjacent to the sponge bundling device 5 and there is no gap at the connection, they are regarded as an integer, and the integral structure 19 of the water-absorbing resin and the sponge bundling device is connected in parallel with the resistor 4 (as shown in FIG. 2); the power supply 1 and the signal processing device 15 are connected in series on the main circuit; and the water-absorbing resin 3 is arranged at a central location of the C-shaped insulating housing 16, the sponge bundling device 5 is arranged on both sides of the water-absorbing resin 3, the resistor 4 is arranged in the middle area of the left side of the C-shaped insulating housing 16, and the power supply 1 and the signal processing device 15 are arranged in the right side of the C-shaped insulating housing 16 (see the interior of the C-shaped insulating housing 16 in FIG. 1). Further, a PVC waterproof tape 2 is arranged at the connection between the wire 6 and the sponge bundling device 5, tightly wrapping the wire 6 and the sponge bundling device 5 to prevent water from being sprayed onto the wire to form a closed loop when the water pipeline leaks and failing to trigger the alarm device. The power supply 1 is lithium battery, which shall be checked and replaced by staff on a regular basis. The signal processing device is composed of an ammeter 9, a relay circuit switch 8, and a wireless signal transmitter 7. The ammeter 9 is connected to the relay circuit switch 8, and the signal processing device has a built-in wireless signal transmitter 7. When a pipeline leaks, the water-absorbing resin 3 and the sponge bundling device 5 absorb moisture to short the circuit; at this moment, the current in the circuit exceeds the current threshold and triggers the relay circuit switch 8; after the signal is received, the wireless signal transmitter 7 transmits the pipeline leakage signal to realize the detection process of the water pipeline leakage. After the power is turned on, a closed loop is formed; since the water-absorbing resin 3 and the sponge bundling device 5 are not conductive, the current returns to the negative electrode through the resistor; when the monitored pipeline leaks, the water-absorbing resin 3 and the sponge bundling device 5 absorb water and become good conductors; and at this moment, the circuit is short-circuited and the current exceeds the current threshold of the signal processing device 15, the built-in relay circuit switch 8 is automatically shut down and triggers the wireless signal transmitter, and the wireless signal transmitter 7 feeds back signals to the ground signal base station 13. After an abnormality is detected, the ground signal base station 13 transmits a wireless signal 14 to the PC 12 to trigger the PLC controller 10 to alarm. The signal feedback principle is that when the current at the signal processing device 15 exceeds the threshold, the relay circuit switch 8 is automatically shut down to cut off the current to protect the power supply; and at the same time, the wireless signal transmitter transmits a leakage signal to the PC via the ground signal base station.

In the preceding solution, the current in the signal processing device 15 is monitored in real time by a built-in ammeter, and the calculation equation is as follows:

$$t = \frac{U}{{R}_{Total}} \qquad ( 1 )$$

$$\frac{1}{{R}_{Total}} = \frac{1}{{R}_{1}} + \frac{1}{{R}_{2}} \qquad ( 2 )$$

Among them, R₁ is the preset resistance, and R₂ is the resistance formed by the water-absorbing resin and the sponge bundling device as an integer. When there is no leakage in the pipeline, R₂ approaches infinity, and the measured current is close to the current allowing the preset resistance; and when there is leakage in the pipeline, R₂ gradually approaches infinitesimal, at this moment, the measured current gradually increases and far exceeds the current threshold set in the signal processing device 15, thereby realizing the monitoring of water pipeline leakage.

In the preceding solution, each pipeline has a corresponding serial number, which can accurately correspond to each pipeline. The serial number corresponds to the signal indicator 11, and the signal indicator 11 corresponding to the device is defined as Lᵢ; and then the working status of the signal indicator 11 can be expressed as:

Lᵢ=n (3)

Lᵢ=y (4)

In Equations (3) and (4), n indicates that the signal indicator 11 of the corresponding device is working normally, indicating that there is no leakage in the pipeline; and y indicates that the signal indicator 11 of the corresponding device is working abnormally, indicating that there is a leak in the pipeline and needs to be handled by staff.

In the preceding solution, a retractable mechanical rod 21 design is adopted to achieve functions in response to the monitoring needs of pipelines with different diameters. The retractable mechanical rod 21 can adapt to pipelines 20 of various diameters by adjusting its length. When the metal hook 18 is operated to separate it, since a hinge structure is provided at the bottom of the C-shaped insulating housing 16, the C-shaped insulating housing 16 can move along the hinge, thereby adjusting the opening size to adapt to pipelines of different sizes, so that the system can effectively monitor leakage of water pipelines of different diameters.

In the preceding solution, the water-absorbing resin 3 plays a role in preventing misjudgment. When water droplets or intermittent water flow are generated in the water pipeline due to external factors such as temperature difference between day and night, the water-absorbing resin 3 can quickly and effectively absorb and lock in moisture, and will not diffuse to the sponge bundling devices 5 at both ends to form a closed loop to cause misjudgment. When the water pipeline leaks and generates continuous water flow, it will exceed the retention capacity of the water-absorbing resin 3, thereby diffusing to the sponge bundling devices 5 at both ends, thus forming a closed loop.

The present disclosure provides a monitoring method for leakage of multi-diameter compatible detachable water pipelines. Adopting the preceding device, the method includes the following steps:
(1) arranging the water-absorbing resin 3 and the sponge bundling device 5 as an integer in the middle of the inner wall of the C-shaped insulating housing 16 cavity, and forming a closed loop with the power supply 1, the resistor 4, and the signal processing device 15 to monitor pipeline leakage;
(2) arranging all devices inside the C-shaped insulating housing 16 cavity, in which the C-shaped insulating housing 16 is fixed by a connector composed of a retractable mechanical rod 21, a metal clamp ring 17, and a metal hook 18, and can be adjusted accordingly according to the pipeline diameter, and the tip of the metal hook 18 returns to the front end of the metal clamp ring 17 to prevent the metal hook 18 from falling off after assembly;
(3) bonding the wire 6 and the sponge bundling device 5 with conductive sol to quickly form a loop after encountering water, thereby accurately monitoring leakage;
(4) fixing the device at the pipeline connection point or maintenance point after the pipeline is arranged or repaired, turning on the power supply 1 switch, starting the PC 12, monitoring the connection point or maintenance point in real time, and reflecting whether the pipeline leaks according to the current value, where when the pipeline leaks, the circuit current being higher than the current threshold set in the signal processing device 15 will trigger the relay circuit switch 8 to shut down the circuit, and at the same time, the wireless signal transmitter 7 transmits a signal to the PC 12 via the ground signal base station 13 so as to realize accurate monitoring of leakage points; and
(5) monitoring the pipeline leakage in real time by the PC 12, where when a feedback abnormal signal is received, the PC will automatically transmit a signal to the ground PLC controller 10, and the signal indicator 11 corresponding to the device serial number will flash to remind the ground staff, thereby avoiding the occurrence of water leakage accidents.

What is claimed is:

1. A monitoring system for leakage of multi-diameter compatible detachable water pipelines, comprising a detachable hinged housing, a PLC controller, a ground signal base station, and a PC;
the detachable hinged housing is arranged outside a pipeline to be monitored; the detachable hinged housing comprises a C-shaped insulating housing and connectors thereof; the C-shaped insulating housing is composed of two arc structures to form a C-shaped structure, one end of the two arc structures is a permeable mesh frame, the other end is connected to a connector, the permeable mesh frame is connected by a hinge, and the two arc structures are fixedly connected by a connector; the C-shaped insulating housing is equipped with a power supply, a resistor, water-absorbing resin, a sponge bundling device, a signal processing device, and several wires inside; the sponge bundling device is composed of a large number of sponge filaments connected together; and the signal processing device is composed of an ammeter, a relay circuit switch, and a wireless signal transmitter; and
the wireless signal transmitter is connected to the ground signal base station, the PC, and the PLC controller in sequence; the wireless signal transmitter can transmit a signal to the ground signal base station, and when the pipeline leakage signal is received, the ground signal base station transmits the signal to the PC; and when the pipeline leakage signal transmitted by the ground signal base station is received, the PC transmits the signal to the PLC controller to control a signal indicator of the corresponding device to flash, reminding the ground staff that the pipeline has leaked.

2. The monitoring system for leakage of multi-diameter compatible detachable water pipelines according to claim 1, wherein the C-shaped insulating housing is made of an insulating plastic material, the water-absorbing resin is arranged above the permeable mesh frame at the bottom of the C-shaped insulating housing, and the water-absorbing resin is arranged in a clustered manner; when the C-shaped insulating housing is opened for disassembly, the clustered structure of the water-absorbing resin is staggered; when the C-shaped insulating housing is combined for assembly, the water-absorbing resin merges into one; and the arrangement of the water-absorbing resin is consistent with a line direction of the mesh in the permeable mesh frame, and when the amount of water absorbed by the water-absorbing resin is too large, water is discharged through the mesh.

3. The monitoring system for leakage of multi-diameter compatible detachable water pipelines according to claim 1, wherein the connector of the C-shaped insulating housing comprises a metal hook, two metal clamp rings, and four retractable mechanical rods; one end of the retractable mechanical rod is connected to the openings at both ends of the C-shaped insulating housing, and the other end is connected to the metal clamp ring; the two metal clamp rings are engaged with the metal hook for clamping connection, so that the C-shaped insulating housing is locked outside the pipeline; sizes of the retractable mechanical rod can be adjusted according to the different diameters of the pipeline to be monitored; and the bottom of the C-shaped insulating housing is connected by adopting a hinge structure, and the hinge structure comprises a pair of blades with pin holes and a rotating shaft passing through the two blades to ensure that the C-shaped insulating housing can be flexibly opened and closed during assembly.

4. The monitoring system for leakage of multi-diameter compatible detachable water pipelines according to claim 3, wherein the telescopic structure of each retractable mechanical rod is designed with multiple inner and outer tubes sleeved, the inner tube is nested inside the outer tube and the diameter of the inner tube gradually decreases; and a gap is formed between the inner tube and the outer tube.

5. The monitoring system for leakage of multi-diameter compatible detachable water pipelines according to claim 1, wherein in the C-shaped insulating housing, the water-absorbing resin is arranged adjacent to the sponge bundling device and there is no gap at the connection, and a combined structure of the water-absorbing resin and the sponge bundling device is connected in parallel with the resistor; the power supply and the signal processing device are connected in series on the main circuit; and the water-absorbing resin is arranged at a central location of the C-shaped insulating housing, the sponge bundling device is arranged on both sides of the water-absorbing resin, the resistor is arranged in the middle area of the left side of the C-shaped insulating housing, and the power supply and the signal processing device are arranged in the right side of the C-shaped insulating housing.

6. The monitoring system for leakage of multi-diameter compatible detachable water pipelines according to claim 5, wherein a PVC waterproof tape is arranged at the connection between the wire and the sponge bundling device for wrapping the wire and the sponge bundling device.

7. The monitoring system for leakage of multi-diameter compatible detachable water pipelines according to claim 5, wherein the power supply is a lithium battery.

8. The monitoring system for leakage of multi-diameter compatible detachable water pipelines according to claim 1, wherein in the preceding solution, each pipeline has a corresponding serial number, the serial number can accurately correspond to each pipeline, and the serial number corresponds to the signal indicator; and if the signal indicator light works normally, it means that there is no leakage in the pipeline; and if the signal indicator does not work properly, it means that there is a leakage in the pipeline.

9. A monitoring method for leakage of multi-diameter compatible detachable water pipelines, adopting the monitoring system for leakage of multi-diameter compatible detachable water pipelines according to claim 1, comprising the following steps of:
(1) arranging the water-absorbing resin and the sponge bundling device as an integer in the middle of the inner wall of the C-shaped insulating housing cavity, and forming a closed loop with the power supply, the resistor, and the signal processing device to monitor pipeline leakage;
(2) arranging all devices inside the C-shaped insulating housing cavity;
(3) bonding the wire and the sponge bundling device with conductive sol to form a loop after encountering water, thereby accurately monitoring leakage;
(4) fixing the device at the pipeline connection point or maintenance point after the pipeline is arranged or repaired, turning on the power supply switch, starting the PC, monitoring the connection point or maintenance point in real time, and reflecting whether the pipeline leaks according to the current value, where when the pipeline leaks, the circuit current being higher than the current threshold set in the signal processing device will trigger the relay circuit switch to shut down the circuit, and at the same time, the wireless signal transmitter transmits a signal to the PC via the ground base station so as to realize accurate monitoring of leakage points; and
(5) monitoring the pipeline leakage in real time by the PC, where when a feedback abnormal signal is received, the PC will automatically transmit a signal to the ground PLC controller, and the signal indicator of corresponding to the device serial number will flash to remind the ground staff.
